(19) United States
(12) Patent Application Publication
(10) Pub. No.: US 2005/0063142 A1
(43) Pub. Date: Mar. 24, 2005

(54) Orientation system for thin printed circuit board and method for orientating the board

(76) Inventor: Yao-Chi Fei, Tao-Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/942,037

(22) Filed: Sep. 16, 2004

(30) Foreign Application Priority Data
Sep. 19, 2003 (TW) 92125851

(51) Int. Cl. H02B 1/00

(52) U.S. Cl. 361/600

(57) ABSTRACT

An orientation system for a thin printed circuit board and a method for orientating the same are provided. The orientation system includes a peelable sticky tape, a substrate, a tape arrangement apparatus, an ultra light device, a regular unit and an impression apparatus. The tape arrangement apparatus coats a layer of glue on the substrate, and after the radiation by the ultra light device; the glue becomes the peelable sticky tape. Then the thin printed circuit board is arranged to orientate in the substrate by the impression apparatus and the regular unit.

### BACKGROUND OF THE INVENTION

1. Field of the Invention

The present invention relates to an orientation system for a thin printed circuit board and a method for orientating the board, and particularly relates to a method for orientating the thin printed circuit board before processed with the high temperature.

2. Background of the Invention

As much progress of technology does, electronic products develop rapidly, so as to provide convenience to modem life. Nevertheless, the electronic products that provide only one function are not satisfied no more, multiple functions and small portable sizes for easy carry are paid more attention. For example, the cell phone develops from large size to small and thin size for manipulation on the palm, so components inside the cell phone should be miniaturized and thinned.

The printed circuit board inside the cell phone can be a rigid board or a flexible board, and has a thickness of about several micrometers for supporting components or received inside the cell phone. Because the printed circuit board is applied with the components in order to provide a stable electrical working environment, the printed circuit board will be fine after the reflow process with high temperature if it is thick enough or it is the rigid board. On the other hand, if the printed circuit board is too thin or is the flexible board, it will bend, warpage, or twist to affect the precise contact between the components and the pads on the printed circuit board because of solder skips, solder shorts or wrong connections. FIG. 1 illustrates a flexible board 20a with a plurality of components 40a, and the flexible board 20a is disposed on a substrate 30a by sticking an adhesive tape 10a in order to avoid the problems of board bending, warpaging, or twisting.

However, there are still some other problems existed in the conventional way referred in FIG. 1:

1. Because the high temperature in the reflow process is higher than 210 degrees centigrade, so the adhesive tape 10a should resist against the high temperature to avoid losing the stickiness thereof. If the adhesive tape 10a cannot stick the flexible board 20a, the flexible board 20a may warp and displace. Furthermore, the adhesive tape 10a is only used for one time; the stickiness of the flexible board 20a should be repeated with a new tape, thus that costs more.

2. Because the stickiness of the flexible board 20a can be automatized hardly, the process will cost much labor and lead to unstable quality.

Hence, an improvement over the prior art is required to overcome the disadvantages thereof.

### SUMMARY OF INVENTION

The primary object of the invention is therefore to specify an orientation system for a thin printed circuit board and a method for orientating the board, in order to save labor and material for cost down by automation.

The secondary object of the invention is therefore to specify an orientation system for a thin printed circuit board and a method for orientating the board, in order to improve the precision of the orientation by avoiding human mistakes, and further to increase the yield rate of product and the utilization ratio of equipment.

According to the invention, these objects are achieved by an orientation system for a thin printed circuit board including a peelable sticky tape, a substrate, a tape arrangement apparatus arranging the peelable sticky tape at a predetermined position of the substrate, and an impression apparatus. The impression apparatus includes a suck-and-press unit, a motive unit, a substrate delivering unit and a table. The suck-and-press unit, the motive unit and the substrate delivering unit are arranged on the table, the suck-and-press unit connects the motive unit and slides on the table, so that the suck-and-press unit sucks the thin printed circuit board, and the motive unit carries the suck-and-press unit in order to enable the suck-and-press unit press the thin printed circuit board onto the substrate, therefore, the thin printed circuit board is pressed to contact with the peelable sticky tape at the predetermined position for precise orientation.

According to the invention, these objects are achieved by a method for orientating a thin printed circuit board including steps of: providing a tape arrangement apparatus, an ultra light device and an impression apparatus first; second, coating a glue on a substrate by the tape arrangement apparatus; in a third step, irradiating UV light on the glue to form as a peelable sticky tape by the ultra light device; in a fourth step, moving the substrate to a first predetermined position by the impression apparatus; in a fifth step, sucking the thin printed circuit board by the impression apparatus; in a sixth step, moving the thin printed circuit board by the impression apparatus to the first predetermined position; and in a seventh step, sticking the thin printed circuit board on the peelable sticky tape of the substrate for orientating the thin printed circuit board on the substrate.

According to the invention, these objects are achieved by an impression apparatus pressing and aligning a thin printed circuit board that includes a table, a motive unit disposed on the table, a substrate delivering unit arranged on the table to pass a substrate, at least one suck-and-press unit connecting the motive unit and sliding on the table, and a regulation unit disposed on the table, in order to adjust and align the thin printed circuit board and the suck-and-press unit. The suck-and-press unit sucks the thin printed circuit board and the motive unit moves the suck-and-press unit.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of the conventional method for orientating a flexible board;

FIG. 2 is a perspective view of an orientation system for a thin printed circuit board according to the present invention;

FIG. 3 is a perspective view of a substrate coated with a peelable sticky tape according to the present invention;

FIG. 4 is a perspective view of the substrate carry the thin printed circuit board according to the present invention;

FIG. 5 is a perspective view of an impression apparatus according to the present invention;

FIG. 5A is an enlarge view of the impression apparatus according to the present invention;

FIG. 6 is another perspective view of the impression apparatus according to the present invention; and

FIG. 7 is a flow chart of a method for orientating the thin printed circuit board according to the present invention.

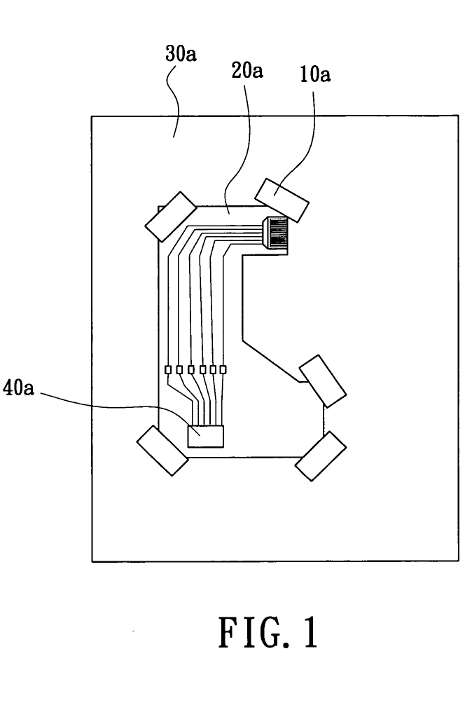

### DETAILED DESCRIPTION OF THE EMBODIMENTS

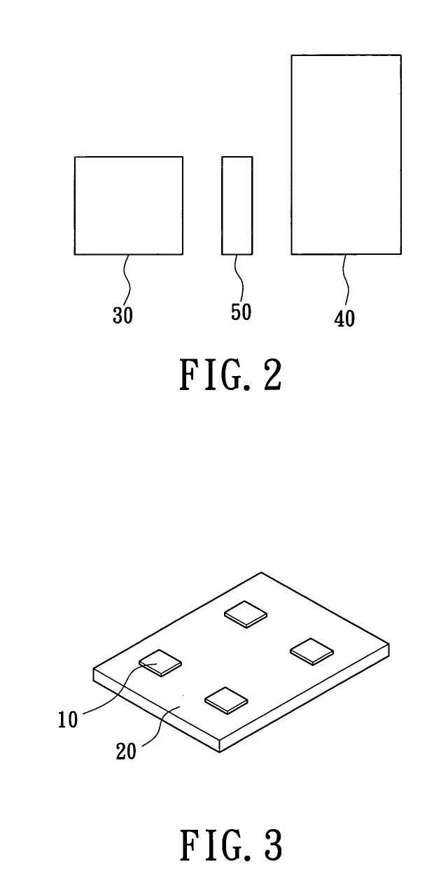

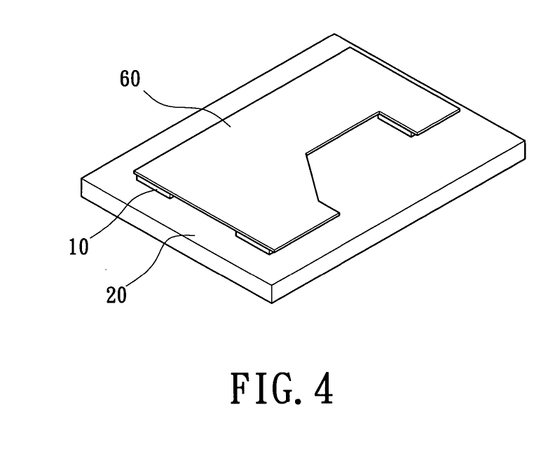

Referring to FIGS. 2 to 4, an orientation system for a thin printed circuit board and the method for orientating the board according to the present invention are disclosed. The orientation system includes a peelable sticky tape 10, a substrate 20, a tape arrangement apparatus 30, an impression apparatus 40 and an ultra light device 50. The tape arrangement apparatus 30 coats a layer of glue on the substrate 20, and after the ultra light device 50 provides the UV ray to irradiate the layer of the glue as the peelable sticky tape 10. Then, to dispose a thin printed circuit board 60 onto the substrate with the peelable sticky tape 10, so that the thin printed circuit board 60 can contact the substrate 20 to avoid failure modes of SMT process, such as bending, warpaging or twisting. After the SMT process is down, the thin printed circuit board 60 can be removed from the peelable sticky tape 10 and the substrate 20 easily.

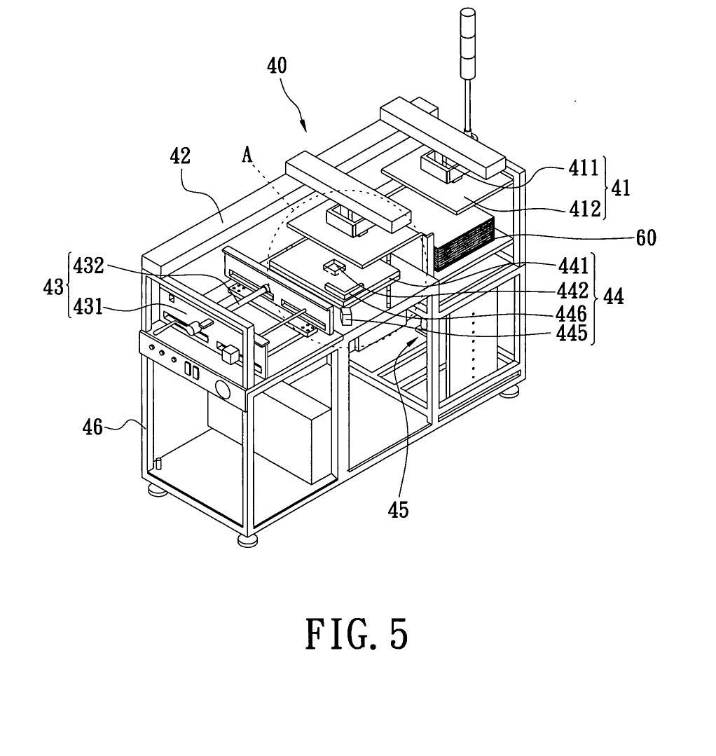

FIGS. 2 and 4 show that the peelable sticky tape 10 is arranged between the substrate 20 and the thin printed circuit board 60 by the tape arrangement apparatus 30. The tape arrangement apparatus 30 is a glue injection or screen-printing machine, and the peelable sticky tape 10 can be made of UV glue, which can harden quickly after the exposure of the UV ray. By the way, the peelable sticky tape 10 can harden without the UV ray but for a long time.

After steps mentioned above, the substrate 20 is delivered to a predetermined position of the impression apparatus 40. The impression apparatus 40 forces the thin printed circuit board 60 to contact the peelable sticky tape 10 of the substrate 20 for orientating the thin printed circuit board 60 onto the substrate 20. The peelable sticky tape 10 won't fail to show the warppage, the solder skip or the solder short of the thin printed circuit board 60, even the SMT process or the reflow process these need high temperature.

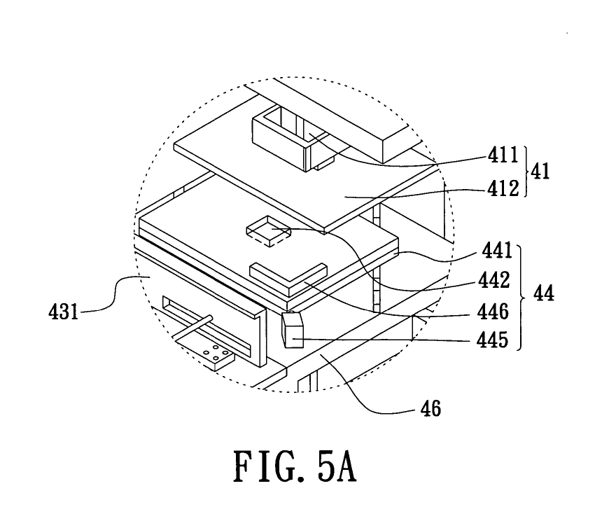

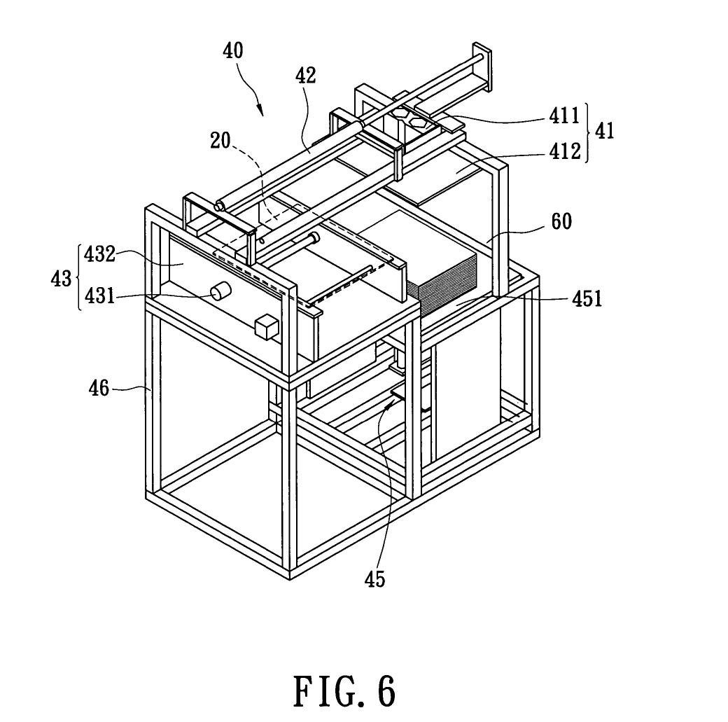

With regards to FIGS. 5 and 6, the impression apparatus 40 includes a suck-and-press unit 41, a motive unit 42, a substrate delivering unit 43, a regulation unit 44, a route-lifting unit 45 and a table 46. The suck-and-press unit 41, the motive unit 42 and the substrate delivering unit 43, the regulation unit 44 and the route-lifting unit 45 are arranged on the table 46. The suck-and-press unit 41 connects the motive unit 42 and slides on the table 46, so that the suck-and-press unit 41 sucks the thin printed circuit board 60, and the motive unit 42 carries the suck-and-press unit 41 in order to enable the suck-and-press unit 41 moves to the route-lifting unit 45 to elevate the thin printed circuit board 60 that is on the route-lifting unit 45, and then the substrate delivering unit 43 passes the substrate 20 to a first predetermined position of the table 46. The suck-and-press unit 41 and the motive unit 42 moves the thin printed circuit board 60 to the first predetermined position, so that the suck-and-press unit 41 can pick the thin printed circuit board 60 up to the substrate 20 via the peelable sticky tape 10 for precise orientation.

The motive unit 42 is a lateral moving apparatus, and the motive unit 42 has an end secured to the table 46 and an opposing end connecting the suck-and-press unit 41. Or the motive unit 42 is a lateral axle, and the suck-and-press unit 41 slides on the lateral axle. The suck-and-press unit 41 includes a lifting cylinder 411 having a top connecting the motive unit 42 and sliding the table 46, and an inhalation plate 412 connecting a bottom of the lifting cylinder 411. The route-lifting unit 45 is disposed by a side of the table 46, and includes an application stage 451, a screw pillar and a motor (not shown). The motor disposes on the table 46, and the screw pillar has an end connecting the motor and an opposite end connecting the application stage 451; the thin printed circuit board 60 is disposed on the application stage 451 and the motor drives the screws in order to elevator the table 46 upwards to a predetermined height, and to decrease the period of time while the inhalation plate 412 sucks the thin printed circuit board 60.

The substrate delivering unit 43 includes two delivery tracks 431 and a width adjustment post 432. One of the delivery tracks 431 is secured to the table 46, to which the width adjustment post 432 has an end pivotally connecting, and the other one of the delivery tracks 431 screwed with an opposing end of the width adjustment post 432. The width adjustment post 432 can be rotated to adjust a space between the two delivery tracks 431, and the substrate 20 can be passed by the two delivery tracks 431 to the first determined position. However, if the thin printed circuit board 60 is a double-sided board, the thin printed circuit board 60 will tilt easily when stacks in the application stage 451 because of arrangements of electronic components and connectors. Thus, the regulation unit 44 is necessary to be provided, in order to adjust and align the thin printed circuit board 60 and the suck-and-press unit 41. The regulation unit 44 is disposed between the substrate delivering unit 43 and the route-lifting unit 45, and includes a motive plate 441, a propel cylinder 445 and a retaining plate 446. The retaining plate 446 is a right angle frame, the propel cylinder 445 pulls the motive plate 441 to enable the thin printed circuit board 60 abut against two adjacent sides of the right angle frame. The motive plate 441 slides on the table 46 and has an indent 442, the retaining plate 446 secures to the table 46 and slides against the motive plate 441, the propel cylinder 445 is disposed on the table 46 and connecting the motive plate 441 to push the thin printed circuit board 46 on the motive plate 441; and the propel cylinder 445 pulls the motive plate 44, so the thin printed circuit board 60 abuts against the retaining plate 446 for adjusting and aligning the thin printed circuit board 60 with the motive plate 441. The suck-and-press unit 41 sucks the thin printed circuit board 60 between the application stage 451 and the motive plate 441. There is another suck-and-press unit 41 responses for sucking the thin printed circuit board 60 between the motive plate 441 and the substrate 20. The motive unit 42 can drive the two suck-and-press units 41 at the same time to improve the manufacture efficiency. When the thin printed circuit board 60 is double side, which has one side arranged with the electronic components and connectors, and the indent 442 is used for received with the electronic components and connectors. For further speeding the process, the two suck-and-press units 41 can suck amount of the thin printed circuit boards 60 by plural pieces for one time and by several times.

FIG. 6 illustrates the thin printed circuit board 60 is single side; the amount of the regular unit 44 can be decreased. Because the single sided boards can be arranged regular easily in the application stage 451, so that the amount of the suck-and-press unit 41 can be only one to side between the application stage 451 and the substrate 20 repeatedly.

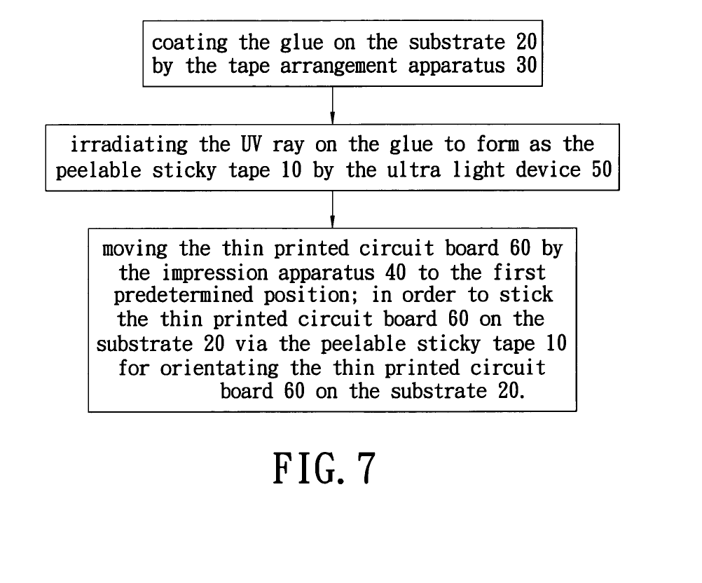

FIG. 7 shows a method for orientating the thin printed circuit board, which includes steps of:
providing the tape arrangement apparatus 30, the ultra light device 50 and the impression apparatus 40;
coating the glue on the substrate 20 by the tape arrangement apparatus 30;
irradiating the UV ray on the glue to form as the peelable sticky tape 10 by the ultra light device 50;
moving the substrate 20 to a first predetermined position by the impression apparatus 40;
sucking the thin printed circuit board 60 by the impression apparatus 40;
moving the thin printed circuit board 60 by the impression apparatus 40 to the first predetermined position; and
sticking the thin printed circuit board 60 on the substrate 20 via the peelable sticky tape 10 for orientating the thin printed circuit board 60 on the substrate 20.

Advantages of the present invention are to save labor and material for cost down by automation, to improve the precision of the orientation by avoiding human mistakes, and further to increase the yield rate of product and the utilization ratio of equipment.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An orientation system for a thin printed circuit board, comprising:
a peelable sticky tape;
a substrate;
a tape arrangement apparatus arranging the peelable sticky tape at a predetermined position of the substrate; and
an impression apparatus including a suck-and-press unit, a motive unit, a substrate delivering unit and a table, wherein the suck-and-press unit, the motive unit and the substrate delivering unit are arranged on the table, the suck-and-press unit connects the motive unit and slides on the table, so that the suck-and-press unit sucks the thin printed circuit board, and the motive unit carries the suck-and-press unit in order to enable the suck-and-press unit press the thin printed circuit board onto the substrate, therefore, the thin printed circuit board is pressed to contact with the peelable sticky tape at the predetermined position for precise orientation.

2. The orientation system as claimed in claim 1, wherein the tape arrangement apparatus is a glue injection machine.

3. The orientation system as claimed in claim 1, wherein the tape arrangement apparatus is a screen-printing machine.

4. The orientation system as claimed in claim 1, further including an ultra light device that provides UV ray on the peelable sticky tape.

5. The orientation system as claimed in claim 1, wherein the peelable sticky tape is made of UV glue.

6. The orientation system as claimed in claim 1, wherein the suck-and-press unit includes a lifting cylinder having a top connecting the motive unit, and an inhalation plate connecting a bottom of the lifting cylinder.

7. The orientation system as claimed in claim 1, wherein the motive unit is a lateral moving apparatus, and the motive unit has an end secured to the table and an opposing end connecting the suck-and-press unit.

8. The orientation system as claimed in claim 1, wherein the motive unit is a lateral axle, and the suck-and-press unit slides on the lateral axle.

9. The orientation system as claimed in claim 1, wherein the substrate delivering unit includes two delivery tracks and a width adjustment post; one of the delivery tracks is secured to the table, to which the width adjustment post has an end pivotally connecting, and the other one of the delivery tracks screwed with an opposing end of the width adjustment post.

10. The orientation system as claimed in claim 1, wherein the impression apparatus includes a regulation unit disposed on the table, in order to adjust and align the thin printed circuit board and the suck-and-press unit.

11. The orientation system as claimed in claim 10, wherein the regulation unit includes a motive plate, a propel cylinder and a retaining plate, the motive plate slides on the table and has an indent, the retaining plate secures to the table and slides against the motive plate, the propel cylinder disposed on the table and connecting the motive plate to push the thin printed circuit board on the motive plate; the propel cylinder pulls the motive plate, so the thin printed circuit board abuts against the retaining plate for adjusting and aligning the thin printed circuit board with the motive plate.

12. The orientation system as claimed in claim 11, wherein the retaining plate is a right angle frame, the propel cylinder pulls the motive plate to enable the thin printed circuit board abut against two adjacent sides of the right angle frame.

13. The orientation system as claimed in claim 1, further including a route-lifting unit disposed over the table, so as to elevate the thin printed circuit board.

14. The orientation system as claimed in claim 13, wherein the route-lifting unit includes an application stage, a screw pillar and a motor, the motor disposes on the table, and the screw pillar has an end connecting the motor and an opposite end connecting the application stage; the thin printed circuit board is disposed on the application stage and the motor drives the screws in order to elevator the table upwards to a predetermined height.

15. A method for orientating a thin printed circuit board, comprising:
providing a tape arrangement apparatus, an ultra light device and an impression apparatus;
coating a glue on a substrate by the tape arrangement apparatus;
irradiating UV rayon the glue to form as a peelable sticky tape by the ultra light device;
moving the substrate to a first predetermined position by the impression apparatus;
sucking the thin printed circuit board by the impression apparatus;
moving the thin printed circuit board by the impression apparatus to the first predetermined position; and
sticking the thin printed circuit board on the substrate via the peelable sticky tape for orientating the thin printed circuit board on the substrate.

16. The method as claimed in claim 15, wherein the glue is coated on the substrate by screen-printing.

17. The method as claimed in claim 15, wherein the glue is coated on the substrate by injecting.

18. The method as claimed in claim 15, further including a step after providing the UV light, the step including:
moving the substrate to the first predetermined position;
sucking the thin printed circuit board;
putting the thin printed circuit board to an align position;
aligning the thin printed circuit board;
sucking the thin printed circuit board from the align position; and
moving the thin printed circuit board to the first predetermined position.

19. An impression apparatus pressing and aligning a thin printed circuit board, comprising:
a table;
a motive unit disposed on the table;
a substrate delivering unit arranged on the table to pass a substrate;
at least one suck-and-press unit connecting the motive unit and sliding on the table, wherein the suck-and-press unit sucks the thin printed circuit board and the motive unit moves the suck-and-press unit; and
a regulation unit disposed on the table, in order to adjust and align the thin printed circuit board and the suck-and-press unit.

20. The method as claimed in claim 19, wherein the suck-and-press unit includes a lifting cylinder having a top connecting the motive unit, and an inhalation plate connecting a bottom of the lifting cylinder.

21. The method as claimed in claim 19, wherein the motive unit is a lateral moving apparatus, and the motive unit has an end secured to the table and an opposing end connecting the suck-and-press unit.

22. The method as claimed in claim 19, wherein the motive unit is a lateral axle, and the suck-and-press unit slides on the lateral axle.

23. The method as claimed in claim 19, wherein the substrate delivering unit includes two delivery tracks and a width adjustment post; one of the delivery tracks is secured to the table, to which the width adjustment post has an end pivotally connecting, and the other one of the delivery tracks screwed with an opposing end of the width adjustment post.

24. The method as claimed in claim 19, wherein the regulation unit includes a motive plate, a propel cylinder and a retaining plate, the motive plate slides on the table and has an indent, the retaining plate secures to the table and slides against the motive plate, the propel cylinder disposed on the table and connecting the motive plate to push the thin printed circuit board on the motive plate; the propel cylinder pulls the motive plate, so the thin printed circuit board abuts against the retaining plate for adjusting and aligning the thin printed circuit board with the motive plate.

25. The method as claimed in claim 24, wherein the retaining plate is a right angle frame, the propel cylinder pulls the motive plate to enable the thin printed circuit board abut against two adjacent sides of the right angle frame.

26. The method as claimed in claim 19, further including a route-lifting unit disposed over the table, so as to elevate the thin printed circuit board.

27. The method as claimed in claim 26, wherein the route-lifting unit includes an application stage, a screw pillar and a motor, the motor disposes on the table, and the screw pillar has an end connecting the motor and an opposite end connecting the application stage; the thin printed circuit board is disposed on the application stage and the motor drives the screws in order to elevator the table upwards to a predetermined height.
